(19) United States
(12) Patent Application Publication
(10) Pub. No.: US 2013/0074508 A1
(43) Pub. Date: Mar. 28, 2013

(54) Fuel Heating in Combined Cycle Turbomachinery

(71) Applicants: John Edward Sholes, Kings Mountain, NC (US); Douglas Frank Beadie, Greer, SC (US); Kamlesh Mundra, Clifton Park, NY (US)

(72) Inventors: John Edward Sholes, Kings Mountain, NC (US); Douglas Frank Beadie, Greer, SC (US); Kamlesh Mundra, Clifton Park, NY (US)

(21) Appl. No.: 13/241,420

(22) Filed: Sep. 23, 2011

(51) Int. Cl. F02C 6/18; F02C 6/04

(52) U.S. Cl. 60/772; 60/784

(57) ABSTRACT

Combined cycle efficiency can be improved by heating fuel in a gas turbine fuel line in two stages using (i) hot water from an HP economizer of a heat recovery steam generator (HRSG) in a second stage and (ii) hot water from an IP economizer of the HRSG and water output flow from the second stage in a first stage. Efficiency may be further improved by adding one or more fuel preheaters using hot water from the IP feedpump and sequential injections of hot water into the fuel.

### BACKGROUND OF THE INVENTION

The invention relates to combined cycle turbomachinery and, more particularly, to improving combined cycle efficiency by heating fuel in a gas turbine fuel line into stages.

Combined cycle turbomachines utilize gas turbines (GT(s)) as prime movers to generate power. These GT engines operate on the Brayton Cycle thermodynamic principle and typically have high exhaust flows and relatively high exhaust temperatures. These exhaust gases, when directed into a heat recovery boiler (typically referred to as a heat recovery steam generator (HRSG)), produce steam that can be used to generate more power. The produced steam can be directed to a steam turbine (ST) to produce additional power. In this manner, a GT produces work via the Brayton Cycle, and a ST produces power via the Rankine Cycle. Thus, the name “combined cycle” is derived.

Fuel gas heating in combined cycle turbomachinery is typically performed to increase the thermal efficiency. In one previous approach, with reference to FIG. 1, hot water extracted from the exit of an IP economizer 34 (i.e., the water entering an IP evaporator) of a heat recovery steam generator (HRSG) 16 is used for fuel gas heating in a fuel heater 44. In this approach, the maximum fuel gas heating temperature is limited by the temperature of the extracted water, which is typically lower than the saturation temperature of the IP evaporator. This approach limits fuel gas heating, thus limiting the efficiency of combined cycle turbomachinery using IP water.

Although higher fuel gas heating temperature improves the thermal efficiency of a turbomachine, a higher operating pressure of the IP evaporator has a detrimental effect on the steam cycle power output and the thermal efficiency of the machine. Therefore, the IP evaporator is typically operated at an optimum pressure in a combined cycle turbomachine, thus limiting the fuel gas heating temperature and the efficiency of the machine.

In order to increase the temperature of the water available for fuel gas heating, water from high pressure (HP) economizers upstream of the IP evaporator may be used. However, using high pressure water considerably increases the cost of fuel gas heating while presenting a reliability concern in the event of a failure. In one known design, the available IP water temperature has limited fuel gas heating to 365° F. Thus, there is a need to improve the thermal cycle efficiency of combined cycle turbomachinery to overcome the problems faced by prior systems.

### BRIEF DESCRIPTION OF THE INVENTION

In an exemplary embodiment, a method of improving efficiency of a combined cycle turbomachine includes the steps of (a) providing a fuel line for inputting fuel into the gas turbine; (b) heating the fuel in a first fuel heater using water input from an intermediate pressure economizer of the HRSG to an inlet of the first fuel heater; (c) heating the fuel in a second fuel heater downstream from the first fuel heater using water input from a high pressure economizer of the HRSG; and (d) directing water output from the second fuel heater to one of an intermediate pressure section of the HRSG or the inlet of the first fuel heater.

In another exemplary embodiment, a method of improving efficiency of a combined cycle turbomachine includes the steps of (a) providing a fuel line for inputting fuel into the gas turbine; and (b) heating the fuel in two stages using (i) hot water from an HP economizer of a heat recovery steam generator (HRSG) in a second stage and (ii) hot water from an IP economizer of the HRSG and water output flow from the second stage in a first stage.

In yet another exemplary embodiment, a fuel heating circuit is utilized in a combine cycle turbomachine. The turbomachine includes a gas turbine, a heat recovery steam generator (HRSG) receiving gas turbine exhaust and generating steam, and a steam turbine receiving the steam from the HRSG. The fuel heating circuit includes a fuel line that supplies fuel to the gas turbine, a first heater on the fuel line that receives hot water output from an intermediate pressure economizer of the HRSG via a heater inlet, and a second heater on the fuel line downstream from the first heater that receives hot water output from a high pressure economizer of the HRSG. An output line from the second heater delivers water output from the second heater to one of an intermediate pressure section of the HRSG or the heater inlet of the first fuel heater.

### BRIEF DESCRIPTION OF THE DRAWINGS

FIG. 1 shows a prior art arrangement for fuel gas heating in combined cycle turbomachinery;

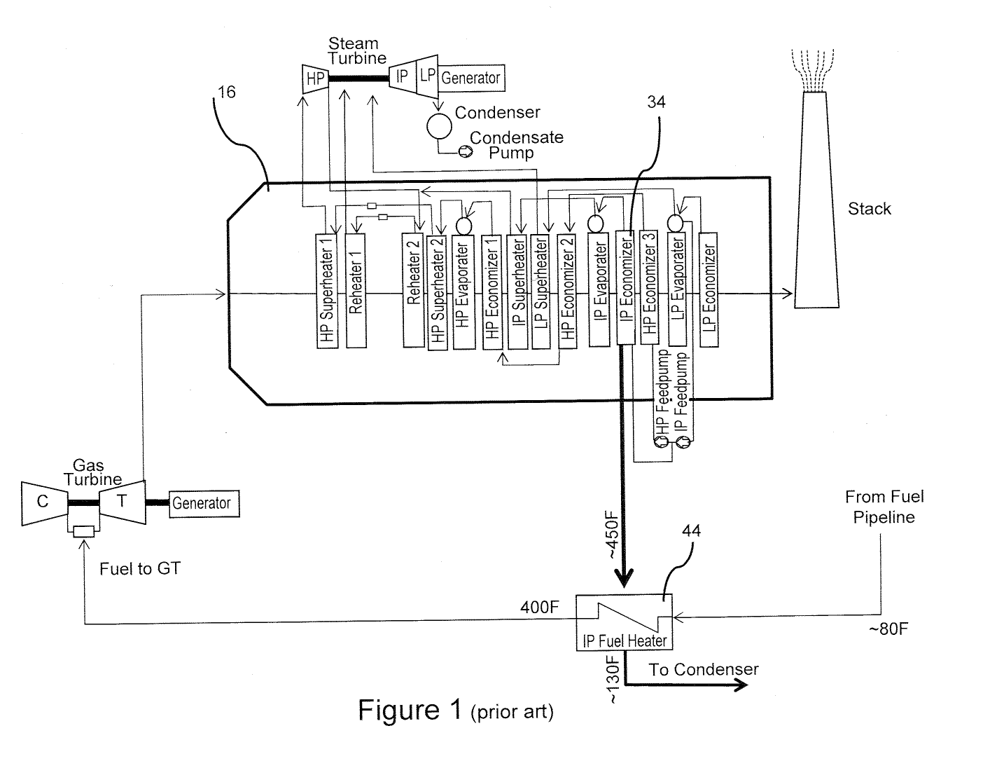

FIG. 2 is a schematic diagram showing a combined cycle turbomachine with a modified fuel heating circuit; and

FIG. 3 is a schematic diagram showing a combined cycle turbomachine with a modified fuel heating circuit with a pre-heater and multiple water injection.

### DETAILED DESCRIPTION OF THE INVENTION

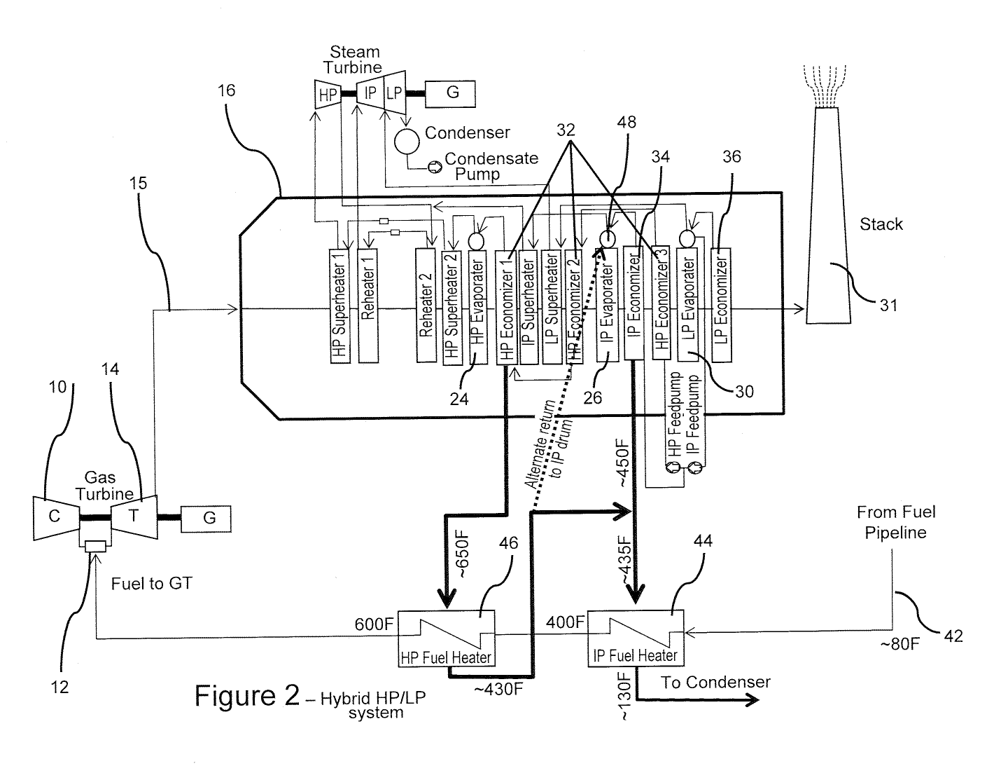

FIG. 2 illustrates a schematic flow diagram of a three-pressure combined cycle turbomachine. The machine includes a compressor 10, a combustor 12, and a turbine powered by expanding hot gases produced in the combustor 12 for driving an electrical generator G. Exhaust gases from the gas turbine 14 are supplied through conduit 15 to a heat recovery steam generator (HRSG) 16 for recovering waste heat from the exhaust gases. The HRSG includes high pressure (HP), intermediate pressure (IP), and low pressure (LP) sections. Each of the HP, IP, and LP sections includes an evaporator section 24, 26, 30, respectively, and an economizer section 32, 34, 36, respectively, for pre-heating water before it is converted to steam in the respective evaporator section. Water is fed to the HRSG 16 to generate steam. Heat recovered from the exhaust gases supplied to the HRSG 16 is transferred to water/steam in the HRSG 16 for producing steam which is supplied to a steam turbine ST for driving a generator. Cooled gases from the HRSG 16 are discharged into atmosphere via an exit duct or stack 31.

With continued reference to FIG. 2, a fuel line 42 carries fuel for the gas turbine 14. Without heating, the fuel is typically at a temperature of about 80° F. A first fuel heater or IP fuel heater 44 is provided in a heat exchange relationship with the fuel line 42, and the fuel is heated with water flow which is a combination of flow from the IP economizer 34 mixed with the outlet water flow from the HP fuel heater 46. The output from the IP economizer 34 is typically about 450° F., which when combined with the 430° F. outlet water flow from the HP fuel heater produces an inlet water flow to the IP fuel heater of about 435° F. and itself could heat the fuel to temperatures of about 400° F.

In order to increase the fuel temperature, the fuel is further heated in a second fuel heater or HP fuel heater 46 on the fuel line 42 downstream from the first heater 44. The second fuel heater 46 utilizes flow from the HP economizer 32, which discharge flow is typically about 650° F. Discharge water from the HP fuel heater 46 at a temperature of about 430° F. may then be mixed with the incoming flow entering the IP fuel heater 44. Alternatively, as shown in FIG. 2, the discharge water can be returned to the IP drum 48. By mixing the HP fuel heater discharge water with the incoming flow entering the IP fuel heater 44, less water flow will be required from the IP economizer 34, resulting in better efficiency. Fuel from the IP fuel heater 44 can reach temperatures of 400° F., and fuel leaving the HP fuel heater 46 can reach temperatures of 600° F. before input to the gas turbine 14.

Using the HP economizer flow will result in an increase in efficiency, but at a cost of combined cycle output. In an exemplary embodiment, the output can be replaced and additional efficiency realized using LP water injection and fuel preheating.

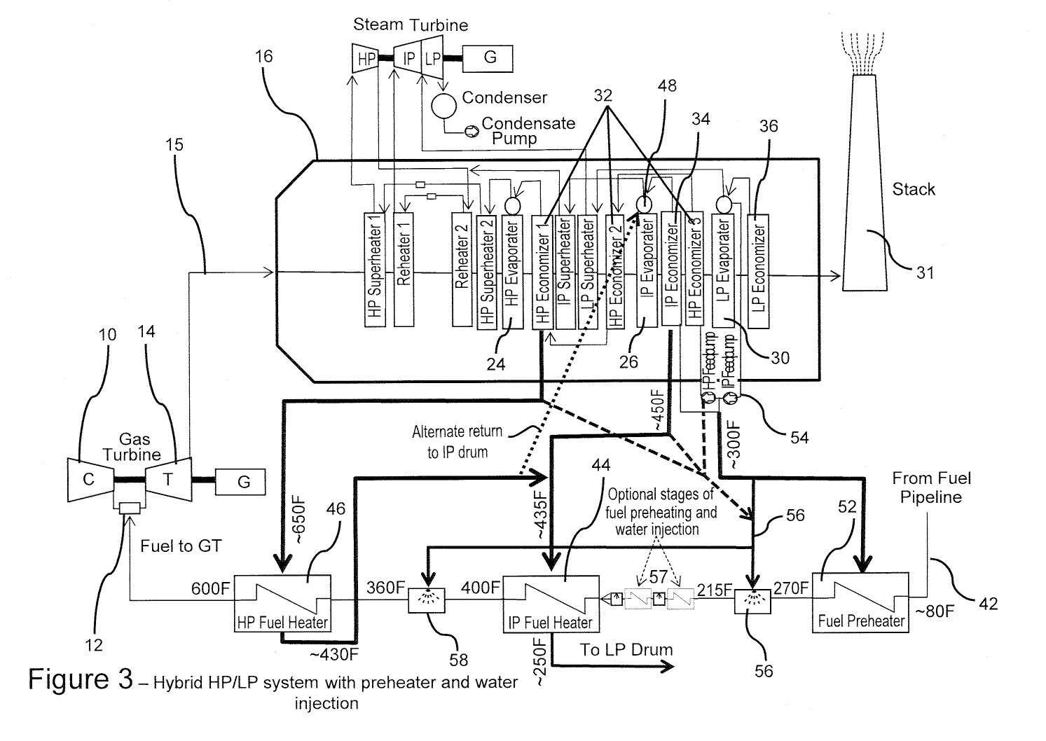

With reference to FIG. 3, a fuel preheater 52 may be positioned upstream of the IP fuel heater 44. The fuel preheater 52 is in a heat exchange relationship with the fuel line and uses tube and shell heat exchangers with discharge from an IP feed pump 54 to heat the fuel to about 270° F. Subsequently, a section of pipe spray 56, with water either from the IP feed pump discharge (or HP feed pump discharge if higher pressure is required to fully atomize the water spray), water is injected/mixed with the fuel in the preheater injector 56. The water may also be supplied from the IP or HP economizer outlet if higher temperature water is required to fully atomize the water spray. The amount of water injection is regulated so as to reach moisture saturation of the fuel.

The fuel temperature after water injection can reach up to 300° F. using additional LP feed water, and in some embodiments, the water may be injected again 57. Each successive water injection brings the fuel moisture closer to about 10% water by volume. The increase in fuel moisture, however, is smaller with each successive heating/water injection cycle. In a preferred construction, three cycles of water injection can be used, but a cost performance trade can be calculated to determine a number of justified cycles. After the preheating/water injection process, the fuel is directed to the IP fuel heater 44.

After the fuel is heated in the IP fuel heater, a section of pipe spray 56, with water from the IP feed pump discharge (or HP feed pump discharge if higher pressure is required to fully atomize the water spray), water is injected/mixed with the fuel in the IP injector 58. The amount of water injection is regulated so as to reach moisture saturation of the fuel.

The saturated fuel is then superheated in the HP fuel heater, giving adequate safety of downstream valves and equipment from damage from fuel borne water droplets.

The system serves to improve combined cycle efficiency. In at least one combined cycle turbomachine, efficiency is increased by 0.2% with increased output of 5-8 MW.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method of improving efficiency of a combined cycle turbomachine, the turbomachine including a gas turbine, a heat recovery steam generator (HRSG) receiving gas turbine exhaust and generating steam, and a steam turbine receiving the steam from the HRSG, the method comprising:
(a) providing a fuel line for inputting fuel into the gas turbine;
(b) heating the fuel in a first fuel heater using water input from an intermediate pressure economizer of the HRSG to an inlet of the first fuel heater;
(c) heating the fuel in a second fuel heater downstream from the first fuel heater using water input from a high pressure economizer of the HRSG; and
(d) directing water output from the second fuel heater to one of an intermediate pressure section of the HRSG or the inlet of the first fuel heater.

2. A method according to claim 1, wherein step (d) is practiced by directing water output from the second fuel heater to the inlet of the first fuel heater.

3. A method according to claim 1, further comprising, prior to step (b), preheating the fuel with water supplied from a feedpump and then injecting water from the feedpump into the fuel.

4. A method according to claim 3, wherein the water for the feedpump is supplied from one of intermediate pressure feedpump discharge or high pressure feedpump discharge.

5. A method according to claim 3, wherein the step of injecting the water from the feedpump into the fuel is practiced by spraying the water via a spray pipe into contact with the fuel.

6. A method according to claim 3, wherein the step of injecting the water from the feedpump into the fuel is practiced until the fuel reaches moisture saturation.

7. A method according to claim 1, wherein steps (a)-(d) are practiced to increase a temperature of the fuel to 500-600° F.

8. A method of improving efficiency of a combined cycle turbomachine, the method comprising:
(a) providing a fuel line for inputting fuel into the gas turbine; and
(b) heating the fuel in two stages using (i) hot water from an HP economizer of a heat recovery steam generator (HRSG) in a second stage and (ii) hot water from an IP economizer of the HRSG and water output flow from the second stage in a first stage.

9. A method according to claim 8, further comprising, prior to step (b), preheating the fuel with water supplied from a feedpump and then injecting water from the feedpump into the fuel.

10. A method according to claim 9, wherein the water for the feedpump is supplied from one of intermediate pressure feedpump discharge or high pressure feedpump discharge.

11. A method according to claim 9, wherein the step of injecting the water from the feedpump into the fuel is practiced by spraying the water via a spray pipe into contact with the fuel.

12. A method according to claim 9, wherein the step of injecting the water from the feedpump into the fuel is practiced until the fuel reaches moisture saturation.

13. A method according to claim 8, wherein steps (a)-(b) are practiced to increase a temperature of the fuel to 500-600° F.

14. A fuel heating circuit for a combine cycle turbomachine, the turbomachine including a gas turbine, a heat recovery steam generator (HRSG) receiving gas turbine exhaust and generating steam, and a steam turbine receiving the steam from the HRSG, the fuel heating circuit comprising:
a fuel line that supplies fuel to the gas turbine;
a first heater on the fuel line, the first heater receiving hot water output from an intermediate pressure economizer of the HRSG via a heater inlet;
a second heater on the fuel line, downstream from the first heater, the second heater receiving hot water output from a high pressure economizer of the HRSG; and
an output line from the second heater delivering water output from the second heater to one of an intermediate pressure section of the HRSG or the heater inlet of the first fuel heater.

15. A fuel heating circuit according to claim 14, wherein the output line from the second heater delivers water output from the second heater to the heater inlet of the first fuel heater.

16. A fuel heating circuit according to claim 14, further comprising a fuel preheater upstream of the first heater, the fuel preheater preheating the fuel with water supplied from a feedpump and then injecting water from the feedpump into the fuel.

17. A fuel heating circuit according to claim 16, wherein the water for the feedpump is supplied from one of intermediate pressure feedpump discharge or high pressure feedpump discharge.

18. A fuel heating circuit according to claim 16, comprising a spray pipe positioned to spray the water from the feedpump into the fuel.
